(19) United States
(12) Patent Application Publication
(10) Pub. No.: US 2025/0325010 A1
(43) Pub. Date: Oct. 23, 2025

(54) TASTE-IMPROVING AGENT, OIL AND/OR FAT COMPOSITION, AND FOOD OR BEVERAGE PRODUCT

(71) Applicant: MIYOSHI OIL & FAT CO., LTD., Tokyo (JP)

(72) Inventors: Yusuke Tomita, Tokyo (JP); Keisuke Uozumi, Tokyo (JP); Akira Ohta, Tokyo (JP)

(21) Appl. No.: 18/250,719

(22) PCT Filed: Nov. 16, 2022
(86) PCT No.: PCT/JP2022/042542

§ 371 Date: Dec. 3, 2024

(30) Foreign Application Priority Data
May 10, 2022 (JP) 2022-077729

(51) Int. Cl. A23L 27/20; A23D 9/00; A23L 27/26

(52) U.S. Cl. CPC A23L 27/2056; A23D 9/00; A23L 27/2026; A23L 27/204; A23L 27/2052; A23L 27/26

(57) ABSTRACT

A sulfurol-containing, taste-improving agent that can provide a good meaty flavor while suppressing any off-flavors derived from sulfurol. The taste-improving agent includes sulfurol and hydroxymethylfurfural and having a mass ratio of the hydroxymethylfurfural to the sulfurol of 0.03 or more and 12.00 or less.

### TECHNICAL FIELD

The present invention relates to a taste-improving agent, an oil and/or fat composition, and a food or beverage product.

### BACKGROUND ART

In recent years, the market for meat alternatives made from plant-derived materials and the market for various seasonings have been growing according to a variety of lifestyles, such as flexitarian, vegetarian, and vegan.

In the field of oils and fats, for example, seasoning oil and other various seasonings are known to enhance the palatability of various foods and beverages. Seasoning oil, also called flavored oil, is an oil and/or fat that has been flavored as desired (e.g., green onion oil, garlic oil). Seasoning oil with a meaty flavor is also known recently.

For example, Patent Document 1 discloses heat cooking oil with a meaty flavor.

Patent Document 1: Japanese Unexamined Patent Application, Publication No. 2005-15683

### DISCLOSURE OF THE INVENTION

### Problems to be Solved by the Invention

The inventors have found that when added to targets (e.g., foods and beverages), sulfurol can provide a meaty flavor.

However, the inventors have found a problem in that when added to some targets, sulfurol may provide off-flavors although it can impart a meaty flavor to the targets.

The present invention has been made in light of the circumstances mentioned above. It is an object of the present invention to provide a sulfurol-containing, taste-improving agent that can provide a good meaty flavor while suppressing any off-flavors derived from sulfurol.

### Means for Solving the Problems

The inventors have completed the present invention based on findings that mixing hydroxymethylfurfural with sulfurol in specific ratios can solve the problem mentioned above. More specifically, the present invention provides the following aspects.

(1) A taste-improving agent including:
sulfurol; and hydroxymethylfurfural, the taste-improving agent having a mass ratio of the hydroxymethylfurfural to the sulfurol of 0.03 or more and 12.00 or less.

(2) The taste-improving agent according to aspect (1), further including phenylethanal.

(3) The taste-improving agent according to aspect (1), further including furfuryl alcohol.

(4) The taste-improving agent according to aspect (1), further including isoamyl alcohol.

(5) The taste-improving agent according to aspect (1), in which the taste-improving agent is for use in a food or beverage product selected from the group consisting of a prepared food product, a soup product, and a meat alternative food product.

(6) A food or beverage product including the taste-improving agent according to any one of aspects (1) to (5).

(7) An oil and/or fat composition including the taste-improving agent according to any one of aspects (1) to (5).

(8) A food or beverage product including the oil and/or fat composition according to aspect (7).

(9) The oil and/or fat composition according to aspect (7), in which the oil and/or fat composition has a mass ratio of POP to PPO of 0.3 or more and 5.0 or less, in which PPO represents a triglyceride with palmitic acid residues in positions 1 and 2 and an oleic acid residue in position 3, and POP represents a triglyceride with palmitic acid residues in positions 1 and 3 and an oleic acid residue in position 2.

### Effects of the Invention

The present invention provides a sulfurol-containing, taste-improving agent that can provide a good meaty flavor while suppressing any off-flavors derived from sulfurol.

### PREFERRED MODE FOR CARRYING OUT THE INVENTION

Hereinafter, embodiments of the present invention will be described, which are not intended to limit the present invention.

### Taste-Improving Agent

The taste-improving agent of the present invention includes sulfurol and hydroxymethylfurfural (HMF) and has a mass ratio of hydroxymethylfurfural (HMF) to sulfurol of 0.03 or more and 12.00 or less. Hereinafter, the “mass ratio of hydroxymethylfurfural to sulfurol” will also be referred to as the “HMF/sulfurol ratio”.

As a result of investigation on various aromatic components, the inventors have found that when added to targets, sulfurol can provide a meaty flavor. However, the inventors have also found that as the amount of sulfurol added increases, the sulfurol-derived off-flavors increase, although the meaty flavor increases.

As a result of further investigation, the inventors have found that using sulfurol in combination with hydroxymethylfurfural and adjusting the HMF/sulfurol ratio to 0.03 or more and 12.00 or less can reduce sulfurol-derived off-flavors with no loss of the meaty flavor provided by the addition of sulfurol. This reduction effect is probably due to the off-flavor masking effect of hydroxymethylfurfural.

As used herein, the term “taste” is intended to include tastes of targets (e.g., foods and beverages) to which the taste-improving agent of the present invention is to be added.

The taste-improving agent of the present invention is a product that is to be added to the target to improve the taste of the target, examples of which include products capable of imparting a meaty flavor to the target. As used herein, the term “taste-improving” is intended to include making the taste of the target better and/or imparting, to the target, a certain taste or flavor not originally present in the target.

As used herein, the term “meat” is intended to include all kinds of edible meat from livestock. Specific examples of meat include beef, pork, chicken, horse meat, sheep meat, and goat meat. The meat may be derived from any part of the animal, which may include not only a muscle part but also a fatty part.

As used herein, the term “meaty flavor” means a flavor reminiscent of meat (especially, cooked meat). Whether or how much such a flavor exists may be determined by the method shown in the EXAMPLES section.

As used herein, the term “sulfurol-derived off-flavors” means off-flavors described as sulfurous odor, beany odor, or metallic taste. Whether or how much such flavors exist may be determined by the method shown in the EXAMPLES section.

As used herein, the expression “suppressing any off-flavors derived from sulfurol” is intended to include keeping the sulfurol-derived off-flavors at a low level and preventing sulfurol from providing any off-flavor.

The present invention also makes it possible to provide a meat-specific “sweet flavor”. As used herein, the term “sweet flavor” means a sweet flavor that spreads around the mouth during chewing of meat (especially cooked fatty pork meat), deriving from both meat and fat components. Whether or how much such a flavor exists may be determined by the method shown in the EXAMPLES section.

The present invention further makes it possible to reduce harsh and astringent tastes. As used herein, the term “harsh and astringent tastes” means tastes that feel unnatural or unusual for food, such as tastes reminiscent of chemicals and tastes that cause a numbing sensation on the tongue. Whether or how much such tastes exist may be determined by the method shown in the EXAMPLES section.

The present invention makes it easy to provide a flavor similar to that of meat (especially cooked fatty pork meat).

Hereinafter, the taste-improving agent of the present invention will be described in detail. As used herein, the unit “ppm” means parts per million, which is by mass unless otherwise specified. For example, “1 ppm” is equal to “0.0001% by mass”.

### Sulfurol

The taste-improving agent of the present invention includes sulfurol (chemical formula: C₆H₉NOS, CAS No. 137-00-8). Sulfurol is also called 4-methyl-5-thiazoleethanol.

In the present invention, sulfurol contributes to enhancing meaty flavor.

In the present invention, sulfurol may be a synthetic product, or it may be a food or beverage product, an extract, or any other product containing sulfurol as a component thereof.

The content of sulfurol in the taste-improving agent may be adjusted according to the desired degree of flavor, taste or other requirements. For ease of providing a sufficient level of meaty flavor, the content of sulfurol in the taste-improving agent preferably has a lower limit of 20 ppm or more, more preferably 40 ppm or more, even more preferably 80 ppm or more. For prevention of harsh and astringent tastes, the content of sulfurol in the taste-improving agent preferably has an upper limit of 730,000 ppm or less, more preferably 90,000 ppm or less, even more preferably 70,000 ppm or less, furthermore preferably 20,000 ppm or less, still more preferably 3,000 ppm or less, yet more preferably 1,000 ppm or less, most preferably 300 ppm or less.

### Hydroxymethylfurfural

The taste-improving agent of the present invention includes hydroxymethylfurfural (chemical formula: C₆H₆O₃, CAS No. 67-47-0). Hydroxymethylfurfural is also called 5-(hydroxymethyl)-2-furaldehyde.

In the present invention, hydroxymethylfurfural is a component that will reduce (mask) the sulfurol-derived off-flavors without reducing the meaty flavor provided by sulfurol.

In the present invention, hydroxymethylfurfural may be a synthetic product, or it may be a food or beverage product, an extract, or any other product containing hydroxymethylfurfural as a component thereof.

The content of hydroxymethylfurfural in the taste-improving agent may be adjusted according to the desired degree of flavor, taste or other requirements. For ease of producing a sufficient level of off-flavor reducing effect, the content of hydroxymethylfurfural in the taste-improving agent preferably has a lower limit of 5 ppm or more, more preferably 10 ppm or more, even more preferably 20 ppm or more, most preferably 40 ppm or more. For prevention of harsh and astringent tastes, the content of hydroxymethylfurfural in the taste-improving agent preferably has an upper limit of 190,000 ppm or less, more preferably 35,000 ppm or less, even more preferably 17,000 ppm or less, furthermore preferably 3,000 ppm or less, still more preferably 300 ppm or less, yet more preferably 150 ppm or less, most preferably 80 ppm or less.

### Other Components

The taste-improving agent of the present invention may or may not contain other components that will not compromise the advantageous effects of the present invention. For enhancement of the meaty flavor provided by sulfurol and for enhancement of a meat-specific sweet flavor, preferred examples of other components include one or more components selected from the group consisting of phenylethanal, furfuryl alcohol, and isoamyl alcohol.

Preferred embodiments of the present invention encompass a taste-improving agent consisting of sulfurol, hydroxymethylfurfural, and one or more components selected from the group consisting of phenylethanal, furfuryl alcohol, and isoamyl alcohol.

### Phenylethanal

The taste-improving agent of the present invention may include phenylethanal (chemical formula: C₈H₈O, CAS No. 122-78-1). Phenylethanal is also called phenylacetaldehyde.

In the present invention, phenylethanal may be a synthetic product, or it may be a food or beverage product, an extract, or any other product containing phenylethanal as a component thereof.

The content of phenylethanal in the taste-improving agent may be adjusted according to the desired degree of flavor, taste or other requirements. For ease of producing an off-flavor masking effect and a meaty flavor- and sweet fat flavor-enhancing effect, the content of phenylethanal in the taste-improving agent preferably has a lower limit of 0.08 ppm or more, more preferably 0.18 ppm or more, even more preferably 0.35 ppm or more. For prevention of harsh and astringent tastes, the content of phenylethanal in the taste-improving agent preferably has an upper limit of 7,500 ppm or less, more preferably 1,000 ppm or less, even more preferably 700 ppm or less, furthermore preferably 200 ppm or less.

### Furfuryl Alcohol

The taste-improving agent of the present invention may include furfuryl alcohol (chemical formula: C₅H₆O₂, CAS No. 98-00-0). Furfuryl alcohol is also called 2-furyl methanol or 2-furan methanol.

In the present invention, furfuryl alcohol may be a synthetic product, or it may be a food or beverage product, an extract, or any other product containing furfuryl alcohol as a component thereof.

The content of furfuryl alcohol in the taste-improving agent may be adjusted according to the desired degree of flavor, taste or other requirements. For ease of producing an off-flavor masking effect and a meaty flavor- and sweet fat flavor-enhancing effect, the content of furfuryl alcohol in the taste-improving agent preferably has a lower limit of 0.03 ppm or more, more preferably 0.08 ppm or more, even more preferably 0.18 ppm or more. For prevention of harsh and astringent tastes, the content of furfuryl alcohol in the taste-improving agent preferably has an upper limit of 4,000 ppm or less, more preferably 500 ppm or less, even more preferably 350 ppm or less, furthermore preferably 100 ppm or less.

### Isoamyl Alcohol

The taste-improving agent of the present invention may include isoamyl alcohol (chemical formula: C₅H₁₂O, CAS No. 123-51-3). Isoamyl alcohol is also called isopentyl alcohol or 3-methyl-1-butanol.

In the present invention, isoamyl alcohol may be a synthetic product, or it may be a food or beverage product, an extract, or any other product containing isoamyl alcohol as a component thereof.

The content of isoamyl alcohol in the taste-improving agent may be adjusted according to the desired degree of flavor, taste or other requirements. For ease of producing an off-flavor masking effect and a meaty flavor- and sweet fat flavor-enhancing effect, the content of isoamyl alcohol in the taste-improving agent preferably has a lower limit of 0.08 ppm or more, more preferably 0.18 ppm or more, even more preferably 0.35 ppm or more. For prevention of harsh and astringent tastes, the content of isoamyl alcohol in the taste-improving agent preferably has an upper limit of 7,500 ppm or less, more preferably 1,000 ppm or less, even more preferably 700 ppm or less, furthermore preferably 200 ppm or less.

### Proportion between Components

The taste-improving agent of the present invention includes at least sulfurol and hydroxymethylfurfural and has a mass ratio of hydroxymethylfurfural to sulfurol (HMF/sulfurol ratio) of 0.03 or more and 12.00 or less.

For easier achievement of the advantageous effects of the present invention, the HMF/sulfurol ratio has a lower limit of 0.03 or more, preferably 0.07 or more, more preferably 0.10 or more.

For easier achievement of the advantageous effects of the present invention, the HMF/sulfurol ratio has an upper limit of 12.0 or less, preferably 10.0 or less, more preferably 4.0 or less, even more preferably 1.5 or less, most preferably 0.7 or less.

For ease of providing a sweet fat flavor, the mass ratio of phenylethanal to sulfurol (phenylethanal/sulfurol ratio) preferably has a lower limit of 0.0004 or more, more preferably 0.0008 or more, even more preferably 0.0015 or more.

For ease of providing a meaty flavor, the mass ratio of phenylethanal to sulfurol (phenylethanal/sulfurol ratio) preferably has an upper limit of 0.5 or less, more preferably 0.3 or less, even more preferably 0.1 or less.

For ease of producing an off-flavor masking effect, the mass ratio of furfuryl alcohol to sulfurol (furfuryl alcohol/sulfurol ratio) preferably has a lower limit of 0.00015 or more, more preferably 0.0004 or more, even more preferably 0.0008 or more.

The mass ratio of furfuryl alcohol to sulfurol (furfuryl alcohol/sulfurol ratio) preferably has an upper limit of 0.3 or less, more preferably 0.15 or less, even more preferably 0.05 or less.

For ease of masking off-flavors and providing a meaty flavor and a sweet fat flavor, the mass ratio of isoamyl alcohol to sulfurol (isoamyl alcohol/sulfurol ratio) preferably has a lower limit of 0.0004 or more, more preferably 0.0008 or more, even more preferably 0.0015 or more.

For ease of providing a sweet fat flavor, the mass ratio of isoamyl alcohol to sulfurol (isoamyl alcohol/sulfurol ratio) preferably has an upper limit of 0.5 or less, more preferably 0.3 or less, even more preferably 0.1 or less.

For ease of providing a sweet fat flavor, the mass ratio of phenylethanal to hydroxymethylfurfural (phenylethanal/hydroxymethylfurfural ratio) preferably has a lower limit of 0.0015 or more, more preferably 0.003 or more, even more preferably 0.005 or more.

For ease of providing a meaty flavor, the mass ratio of phenylethanal to hydroxymethylfurfural (phenylethanal/hydroxymethylfurfural ratio) preferably has an upper limit of 2 or less, more preferably 1 or less, even more preferably 0.5 or less.

For ease of masking off-flavors, the mass ratio of furfuryl alcohol to hydroxymethylfurfural (furfuryl alcohol/hydroxymethylfurfural ratio) preferably has a lower limit of 0.0005 or more, more preferably 0.0015 or more, even more preferably 0.003 or more.

For ease of providing a meaty flavor, the mass ratio of furfuryl alcohol to hydroxymethylfurfural (furfuryl alcohol/hydroxymethylfurfural ratio) preferably has an upper limit of 2 or less, more preferably 1 or less, even more preferably 0.4 or less.

For ease of masking off-flavors and providing a meaty flavor and a sweet fat flavor, the mass ratio of isoamyl alcohol to hydroxymethylfurfural (isoamyl alcohol/hydroxymethylfurfural ratio) preferably has a lower limit of 0.0015 or more, more preferably 0.003 or more, even more preferably 0.006 or more.

For ease of providing a sweet fat flavor, the mass ratio of isoamyl alcohol to hydroxymethylfurfural (isoamyl alcohol/hydroxymethylfurfural ratio) preferably has an upper limit of 2 or less, more preferably 1 or less, even more preferably 0.4 or less.

### Oil and/or Fat Composition

The present invention also encompasses an oil and/or fat composition including the taste-improving agent of the present invention.

The oil and/or fat composition of the present invention refers to a composition including: an oil and/or fat; and the taste-improving agent of the present invention. Preferred embodiments of the present invention encompass an oil and/or fat composition consisting of: an oil and/or fat; and the taste-improving agent of the present invention.

### Taste-Improving Components

The oil and/or fat composition of the present invention may include any amounts of taste-improving components (i.e., sulfurol, hydroxymethylfurfural, and one or more components selected from the group consisting of phenylethanal, furfuryl alcohol, and isoamyl alcohol) as long as the HMF/sulfurol ratio is 0.03 or more and 12.00 or less.

The contents of taste-improving components in the oil and/or fat composition of the present invention may satisfy the conditions listed in the “Proportion between Components” section of the description regarding the taste-improving agent of the present invention.

For ease of providing a sufficient level of meaty flavor, the content of sulfurol in the oil and/or fat composition preferably has a lower limit of 20 ppm or more, more preferably 40 ppm or more, even more preferably 80 ppm or more. For prevention of harsh and astringent tastes, the content of sulfurol in the oil and/or fat composition preferably has an upper limit of 730,000 ppm or less, more preferably 90,000 ppm or less, even more preferably 70,000 ppm or less, furthermore preferably 20,000 ppm or less, still more preferably 3,000 ppm or less, yet more preferably 1,000 ppm or less, most preferably 300 ppm or less.

The content of sulfurol in the oil and/or fat composition may be determined by the method described below, which is called the external standard method, using SPME (solid phase microextraction) for gas chromatography. First, sulfurol is diluted with MCT (medium chain triglyceride) to prepare four standard samples having sulfurol concentrations of 2.0 ppm, 200 ppm, 2,000 ppm, and 20,000 ppm. These samples are subjected to gas chromatography, and the area of the peak at an ion mass of 112 (molecular ion) is counted and used to plot a calibration curve. The retention time is also recorded. Next, the oil and/or fat composition to be analyzed is subjected to gas chromatography, and the area of the peak at an ion mass of 112 (molecular ion), which is at the same retention time as that of the standard sample, is counted. The resulting count is used to determine the content of sulfurol in the oil and/or fat composition from the calibration curve. If predicted to have a concentration exceeding the range of the calibration curve, the sample should be diluted with MCT before being subjected to the analysis.

For ease of producing a sufficient level of off-flavor reducing effect, the content of hydroxymethylfurfural in the oil and/or fat composition preferably has a lower limit of 5 ppm or more, more preferably 10 ppm or more, even more preferably 20 ppm or more, most preferably 40 ppm or more. For prevention of harsh and astringent tastes, the content of hydroxymethylfurfural in the oil and/or fat composition preferably has an upper limit of 190,000 ppm or less, more preferably 35,000 ppm or less, even more preferably 17,000 ppm or less, furthermore preferably 3,000 ppm or less, still more preferably 300 ppm or less, yet more preferably 150 ppm or less, most preferably 80 ppm or less.

The content of hydroxymethylfurfural in the oil and/or fat composition may be determined by the method described below, which is called the external standard method, using SPME (solid phase microextraction) for gas chromatography. First, four standard samples are prepared having hydroxymethylfurfural concentrations of 1 ppm, 100 ppm, 1,000 ppm, and 10,000 ppm. These samples are subjected to gas chromatography, and the area of the peak at an ion mass of 126 (molecular ion) is counted and used to plot a calibration curve. The retention time is also recorded. Next, the oil and/or fat composition to be analyzed is subjected to gas chromatography, and the area of the peak at an ion mass of 126 (molecular ion), which is at the same retention time as that of the standard sample, is counted. The resulting count is used to determine the content of hydroxymethylfurfural in the oil and/or fat composition from the calibration curve. If predicted to have a concentration exceeding the range of the calibration curve, the sample should be diluted with MCT before being subjected to the analysis.

For ease of producing an off-flavor masking effect and a meaty flavor- and sweet fat flavor-enhancing effect, the content of phenylethanal in the oil and/or fat composition preferably has a lower limit of 0.08 ppm or more, more preferably 0.18 ppm or more, even more preferably 0.35 ppm or more. For prevention of harsh and astringent tastes, the content of phenylethanal in the oil and/or fat composition preferably has an upper limit of 7,500 ppm or less, more preferably 1,000 ppm or less, even more preferably 700 ppm or less, furthermore preferably 200 ppm or less.

The content of phenylethanal in the oil and/or fat composition may be determined by the method described below, which is called the external standard method, using SPME (solid phase microextraction) for gas chromatography. First, four standard samples are prepared having phenylethanal concentrations of 0.01 ppm, 1 ppm, 10 ppm, and 100 ppm. These samples are subjected to gas chromatography, and the area of the peak at an ion mass of 120 (molecular ion) is counted and used to plot a calibration curve. The retention time is also recorded. Next, the oil and/or fat composition to be analyzed is subjected to gas chromatography, and the area of the peak at an ion mass of 120 (molecular ion), which is at the same retention time as that of the standard sample, is counted. The resulting count is used to determine the content of phenylethanal in the oil and/or fat composition from the calibration curve. If predicted to have a concentration exceeding the range of the calibration curve, the sample should be diluted with MCT before being subjected to the analysis.

For ease of producing an off-flavor masking effect and a meaty flavor- and sweet fat flavor-enhancing effect, the content of furfuryl alcohol in the oil and/or fat composition preferably has a lower limit of 0.03 ppm or more, more preferably 0.08 ppm or more, even more preferably 0.18 ppm or more. For prevention of harsh and astringent tastes, the content of furfuryl alcohol in the oil and/or fat composition preferably has an upper limit of 4,000 ppm or less, more preferably 500 ppm or less, even more preferably 350 ppm or less, furthermore preferably 100 ppm or less.

The content of furfuryl alcohol in the oil and/or fat composition may be determined by the method described below, which is called the external standard method, using SPME (solid phase microextraction) for gas chromatography. First, four standard samples are prepared having furfuryl alcohol concentrations of 0.01 ppm, 1 ppm, 10 ppm, and 100 ppm. These samples are subjected to gas chromatography, and the area of the peak at an ion mass of 98 (molecular ion) is counted and used to plot a calibration curve. The retention time is also recorded. Next, the oil and/or fat composition to be analyzed is subjected to gas chromatography, and the area of the ion (molecular ion) mass peak at the same retention time as that of the standard sample is counted. The resulting count is used to determine the content of furfuryl alcohol in the oil and/or fat composition from the calibration curve. If predicted to have a concentration exceeding the range of the calibration curve, the sample should be diluted with MCT before being subjected to the analysis.

For ease of producing an off-flavor masking effect and a meaty flavor- and sweet fat flavor-enhancing effect, the content of isoamyl alcohol in the oil and/or fat composition preferably has a lower limit of 0.08 ppm or more, more preferably 0.18 ppm or more, even more preferably 0.35 ppm or more. For prevention of harsh and astringent tastes, the content of isoamyl alcohol in the oil and/or fat composition preferably has an upper limit of 7,500 ppm or less, more preferably 1,000 ppm or less, even more preferably 700 ppm or less, furthermore preferably 200 ppm or less.

The content of isoamyl alcohol in the oil and/or fat composition may be determined by the method described below, which is called the external standard method, using SPME (solid phase microextraction) for gas chromatography. First, four standard samples are prepared having isoamyl alcohol concentrations of 0.01 ppm, 1 ppm, 10 ppm, and 100 ppm. These samples are subjected to gas chromatography, and the area of the peak at an ion mass of 42 (molecular ion) is counted and used to plot a calibration curve. The retention time is also recorded. Next, the oil and/or fat composition to be analyzed is subjected to gas chromatography, and the area of the ion (molecular ion) mass peak at the same retention time as that of the standard sample is counted. The resulting count is used to determine the content of isoamyl alcohol in the oil and/or fat composition from the calibration curve. If predicted to have a concentration exceeding the range of the calibration curve, the sample should be diluted with MCT before being subjected to the analysis.

### Oil and/or Fat

Edible oil and/or fat is usually used as the oil and/or fat. Examples of the edible oil and/or fat include vegetable oil and/or fat, animal oil and/or fat, synthetic oil and/or fat, and processed oil and/or fat. They may be used singly, or two or more of them may be used in the form of an oil and/or fat mixture.

The present invention makes it possible to provide a good meaty flavor even without using any animal-derived ingredient. In other words, the present invention makes it possible to provide a good meaty flavor even in a case where the oil and/or fat includes only non-animal oil and/or fat (preferably only vegetable oil and/or fat, and/or processed vegetable oil and/or fat).

Examples of the vegetable oil and/or fat include rapeseed oil (canola oil), sunflower oil, coconut oil, palm oil, soybean oil, corn oil, sesame oil, shiso oil, linseed oil, peanut oil, safflower oil, high oleic safflower oil, high oleic sunflower oil, cottonseed oil, grape seed oil, macadamia nut oil, hazelnut oil, pumpkin seed oil, walnut oil, camellia oil, tea seed oil, perilla oil, borage oil, olive oil, rice bran oil, wheat germ oil, cocoa fat, palm kernel oil, and algae oil.

Examples of the animal oil and/or fat include fish oil (oil and/or fat derived from tuna, mackerel, sardine, bonito, herring, or other fish), pork fat, beef fat, milkfat, sheep fat, and chicken oil.

Examples of the synthetic oil and/or fat include medium chain triglyceride oil and diacylglycerol.

The processed oil and/or fat may be any one of the above oils and/or fats having undergone a desired process. Examples of such a process include fractionation (e.g., for producing fractionated oil and/or fat, such as fractionated low-melting-point milkfat or palm super olein), hardening, and transesterification reaction. The oil and/or fat may have undergone one or more processes.

Examples of the oil and/or fat preferably used in the present invention include rapeseed oil (canola oil), sunflower oil, coconut oil, palm oil, fractionated palm-based oil, transesterified palm oil, transesterified oil of a 1:1 mixture of palm kernel oil and palm oil, and transesterified oil of a soft fraction of palm oil.

For ease of providing a meaty flavor, the solid fat content (SFC) of the oil and/or fat composition of the present invention at 20° C. preferably has a lower limit of 5 or more, more preferably 10 or more. For ease of producing an off-flavor masking effect, the solid fat content (SFC) of the oil and/or fat composition of the present invention at 20° C. preferably has an upper limit of 60 or less, more preferably 35 or less.

For ease of producing an off-flavor masking effect, the solid fat content (SFC) of the oil and/or fat composition of the present invention at 30° C. preferably has a lower limit of 3 or more. For ease of providing a sweet fat flavor, the solid fat content (SFC) of the oil and/or fat composition of the present invention at 30° C. preferably has an upper limit of 12 or less.

The content of triolein, which has three oleic acid residues esterified to a molecule of glycerol, in the triglycerides of the edible oil and/or fat in the oil and/or fat composition of the present invention is preferably 0% by mass or more and 50% by mass or less, more preferably 0% by mass or more and 30% by mass or less, even more preferably 2% by mass or more and 10% by mass or less.

The content of tripalmitin, which has three palmitic acid residues esterified to a molecule of glycerol, in the triglycerides of the edible oil and/or fat in the oil and/or fat composition of the present invention is preferably 0% by mass or more and 20% by mass or less, more preferably 1% by mass or more and 12% by mass or less.

In the oil and/or fat composition of the present invention, the triglycerides of the edible oil and/or fat preferably have a POP content of 1.0% by mass or more and 30% by mass or less, more preferably 1.0% by mass or more and 25% by mass or less, even more preferably 5.0% by mass or more and 22% by mass or less, in which POP represents a triglyceride with palmitic acid residues in positions 1 and 3 and an oleic acid residue in position 2. When used as plastic fat, the oil and/or fat composition with a POP content in that range can easily have good plasticity.

In the oil and/or fat composition of the present invention, the triglycerides of the edible oil and/or fat preferably have a PPO content of 2.0% by mass or more and 20% by mass or less, more preferably 6.0% by mass or more and 20% by mass or less, in which PPO represents a triglyceride with palmitic acid residues in positions 1 and 2 and an oleic acid residue in position 3. When used as plastic fat, the oil and/or fat composition with a PPO content in that range can easily have good plasticity.

The oil and/or fat composition of the present invention preferably has a mass ratio of POP to PPO (POP/PPO ratio) of 0.3 or more and 5.0 or less. As the PPO content increases relative to the POP content, the crystallization speed increases, and the oil and/or fat composition can be easily kneaded in a production machine.

If the oil and/or fat composition has a POP/PPO ratio of 1.0 or more, its crystallization speed can be limited to a suitable level and it can be prevented from being excessively kneaded in a production machine and thus can be easily made firm and highly plastic. From this point of view, the POP/PPO ratio preferably has a lower limit of 0.5 or more.

If the oil and/or fat composition has a POP/PPO ratio of 5.0 or less, it has an appropriately high PPO content and can easily have good plasticity. From this point of view, the POP/PPO ratio preferably has an upper limit of 4.0 or less, more preferably 3.0 or less.

In the present invention, the constituent triglycerides may be analyzed by gas chromatography (see The JOCS (Japan Oil Chemists' Society) Standard Methods for the Analysis of Fats, Oils and Related Materials, 2.4.2.2-2013 Fatty Acid Composition (FID Temperature Programmed Gas Chromatography) and Recommended 2-2013 Composition of Fatty Acids in 2-Position).

### Other Components

The oil and/or fat composition of the present invention may contain any food material or additive that is known for use in food or beverage products to the extent as long as it does not compromise the advantageous effects of the present invention.

Examples of the food material include saccharides, tea leaves, vegetables, fruits, spices, yeast, yeast extracts, flavored edible oils (e.g., green onion oil, hot sesame oil, Chinese pepper oil, onion oil, garlic oil, ginger oil, mushroom oil, porcini mushroom oil, truffle oil, bamboo shoot oil, horseradish oil, Yuzu oil, roasted soy sauce oil), virgin coconut oil, virgin olive oil, virgin corn oil, and smoked oil.

Examples of the food additive include emulsifiers, antioxidants, silicones, colorants, flavors, vitamins, and pH adjusting agents.

The type and amount of the food material or additive may be selected as appropriate depending on the desired effect. The food material or additive may be used in combination with the oil and/or fat composition of the present invention to produce, for example, a flavor- or color-adjusting effect, an oxidation- or degradation-preventing effect, a function-enhancing effect, or any other advantageous effect.

The present invention makes it possible to provide a good meaty flavor even without using any animal-derived ingredient. In other words, the present invention makes it possible to provide a good meaty flavor even without using any animal-derived food material (e.g., meat) or any animal-derived food additive (e.g., meat-derived components such as animal extracts).

For ease of achieving the advantageous effects of the present invention, the oil and/or fat composition of the present invention preferably contains substantially or completely no moisture. As used herein, the expression “the oil and/or fat composition contains substantially no moisture” means that the water content of the oil and/or fat composition is at most 0.5% by mass based on the total mass of the oil and/or fat composition. As used herein, the expression “the oil and/or fat composition contains completely no moisture” means that the water content of the oil and/or fat composition is 0.0% by mass based on the total mass of the oil and/or fat composition. As used herein, the term “moisture” means water (H₂O). The water content of the oil and/or fat composition of the present invention may be measured according to The JOCS Standard Methods for the Analysis of Fats, Oils and Related Materials 2.1.3. 4-2013 Moisture (Karl Fischer Method).

### Method for Producing the Taste-Improving Agent

The taste-improving agent of the present invention may be produced by appropriately mixing and stirring the components using a stirrer or other stirring means. The components may be mixed in any order and in any way.

### Method for Producing the Oil and/or Fat Composition

The oil and/or fat composition of the present invention may be produced by appropriately mixing and stirring the components using a stirrer or other stirring means. The components may be mixed in any order and in any way. Some or all of the components for the taste-improving agent of the present invention may be mixed in advance, and the resulting mixture may be mixed with oil and/or fat. Alternatively, the components may be individually mixed with oil and/or fat. The product resulting from the mixing may also be rapidly cooled and kneaded in a cooling mixer to form a plastic oil and/or fat composition.

The taste-improving components (sulfurol, hydroxymethylfurfural, and one or more components selected from the group consisting of phenylethanal, furfuryl alcohol, and isoamyl alcohol) may be added to the oil and/or fat composition as synthetic products, as food or beverage products or extracts containing each component as a part thereof, or as food or beverage products or extracts being synthesized during a process, such as heating. The synthetic products may be commercially available reagents or flavors.

A food material and/or a food additive containing some or all of the above taste-improving components may also be used. Examples of such a food material and/or such a food additive include meat, saccharides, tea leaves, vegetables (e.g., green onion, onion, celery, carrot, tomato, potato), fruits (e.g., banana, lemon, melon, strawberry, coconut), soy sauce, miso, spices (e.g., anise, allspice, caraway, cumin, clove, coriander, cinnamon, star anise, sage, thyme, nutmeg, basil, paprika, pimento, pink pepper, black pepper, white pepper, mace, lemongrass, rose hip, rosemary, laurel), flavored edible oils (e.g., green onion oil, hot sesame oil, Chinese pepper oil, onion oil, garlic oil, ginger oil, mushroom oil, porcini mushroom oil, truffle oil, bamboo shoot oil, horseradish oil, Yuzu oil, roasted soy sauce oil), virgin coconut oil, virgin olive oil, virgin corn oil, smoked liquid, smoked oil, alcoholic beverages (e.g., sake, distilled spirit, wine, beer, whiskey, vodka), mirin, miso, soy sauce, soy sauce lees, koji, shio koji, amazake, sake lees, mirin lees, Nara-zuke, honey, pork, cheese, coffee, coffee lees, soba, chocolate, protein hydrolysates, peptides, amino acids, nucleic acids, vitamins, minerals, yeast extracts, flavors, and any combination thereof. The food material may be used directly without being processed or may be used after being processed (e.g., heated). For example, the above food material may be immersed in oil and/or fat, which may be followed by heating, filtration, and other steps, so that the oil and/or fat composition of the present invention is obtained.

### Uses of the Oil and/or Fat Composition

The oil and/or fat composition of the present invention may be used for any purpose, such as an alternative to seasoning oil known in the art, or may be used in combination with any seasoning (e.g., seasoning oil known in the art).

The oil and/or fat composition of the present invention may be added to any food or beverage product to form a food or beverage product with a good meaty flavor and less off-flavors. Therefore, the present invention also encompasses food and beverage products containing the oil and/or fat composition of the present invention and preferably encompasses meat alternative food products containing the oil and/or fat composition of the present invention.

Examples of the food and beverage products, to which the oil and/or fat composition of the present invention may be added, include, but are not limited to, any product using oil and/or fat such as various prepared foods (e.g., fried foods), confections, breads, soups (e.g., consommé soups containing animal-derived ingredients, soups containing vegetable broth), and sauces. Among them, prepared foods, soups, and meat alternative food products are preferred for easier achievement of the advantageous effects of the present invention.

The oil and/or fat composition of the present invention may be directly added to a food or beverage product. The oil and/or fat composition of the present invention may be used as one of the ingredients of various forms (e.g., frying oil, margarine, fat spread, shortening, edible oil and/or fat, flavored edible oil, an oil-in-water emulsion product (e.g., concentrated milk, whipping cream, mayonnaise), powdered oil and/or fat, dressing).

The present invention makes it possible to provide a good meaty flavor without using any animal-derived ingredient. For example, therefore, the present invention makes it possible to impart a good meaty flavor to meat alternative food products. The present invention also makes it possible to impart a good sweet flavor to meat alternative food products.

As used herein, the term “meat alternative food product” is intended to include any food products produced using a vegetable raw material, such as beans (e.g., soybeans, peas, chickpeas, horse beans), rice, grains, or fungus protein (e.g., mycoprotein) as a main raw material. For ease of achieving the advantageous effects of the present invention, the meat alternative food product according to the present invention is preferably free of any animal-derived ingredient (e.g., meat, meat-derived components, animal oil and/or fat, milk constituents, egg).

Examples of the meat alternative food product include tofu hamburger, soy protein processed foods (e.g., hamburger-like foods, Shumai (Shao-mai)-like foods, dumpling (jiao-zi)-like foods, Chinese bun-like foods, jerky-like foods, sausage-like foods, pizza-like foods, tortilla-like foods), and pea protein processed foods (e.g., hamburger-like foods, Shumai (Shao-mai)-like foods, dumpling (jiao-zi)-like foods, Chinese bun-like foods, jerky-like foods, sausage-like foods, pizza-like foods, tortilla-like foods).

The content of the oil and/or fat composition of the present invention in the meat alternative food product may be adjusted as appropriate according to the desired flavor or other requirements. The content of the oil and/or fat composition of the present invention in the meat alternative food product preferably has a lower limit of 0.50% by mass or more, more preferably 1.0% by mass or more, based on the total mass of the materials for the meat alternative food product. The content of the oil and/or fat composition of the present invention in the meat alternative food product preferably has an upper limit of 90% by mass or less, more preferably 80% by mass or less, based on the total mass of the materials for the meat alternative food product.

### EXAMPLES

Hereinafter, the present invention will be described in more detail with reference to examples, which are not intended to limit the present invention.

### Test 1: Preparation and Evaluation of Taste-Improving Agents and Oil/Fat Compositions

Taste-improving agents and oil/fat compositions were prepared by the process shown below and evaluated for flavor by the method shown below.

### Preparation of Taste-Improving Agents and Oil/Fat Compositions

The components listed in the “Taste-improving agent” column of Tables 1 to 5 were added at the concentrations (in units of ppm) listed therein to the targets listed in the “Addition target food” column of Tables 1 to 5. In this regard, the composition obtained when the “addition target food” is oil/fat (such as rapeseed oil, sunflower oil, coconut oil, palm oil, or processed oil/fat) corresponds to the oil and/or fat composition of the present invention.

In Tables 1 to 5, the symbols (A), (B), (C), (D), and (E) are assigned to the components of the taste-improving agent. The ratio indicated using “(A)” as the denominator, such as the ratio (B)/(A), is the mass ratio of the content of each component other than sulfurol to the content of sulfurol in each taste-improving agent (each component/sulfurol ratio). The ratio indicated using “(B)” as the denominator, such as the ratio (C)/(B), is the mass ratio of the content of each component other than hydroxymethylfurfural to the content of hydroxymethylfurfural in each taste-improving agent (each component/hydroxymethylfurfural ratio).

In Tables 1 to 5, the term “solid fat content” refers to the solid fat content (SFC) of the “addition target food” at 20° C. or 30° C. in each example. The solid fat content was measured according to The JOCS Standard Methods for the Analysis of Fats, Oils and Related Materials, 2.2.9-2013 Solid Fat Content (NMR Method).

The processed oils or fats used are shown below.
Processed oil/fat 1: Middle melting point fraction of palm oil
Processed oil/fat 2: Transesterified palm oil
Processed oil/fat 3: Transesterified 1:1 mixture of palm kernel oil and palm oil
Processed oil/fat 4: 1:1 Mixture of palm oil and transesterified oil of a soft fraction of palm oil (iodine value 56)

### Evaluation of Oil/Fat Compositions

The resulting oil/fat compositions were each subjected to sensory evaluation for off-flavor, meaty flavor, sweet fat flavor, harsh and astringent tastes, and plasticity using the method shown below. The results are shown in the “Evaluation” column of Tables 1 to 5.

The sensory evaluation was carried out by panelists who were selected as described below. Panelist candidates took a five-taste identification test (sweet, sour, salty, bitter, and umami), a taste intensity discrimination test, a food taste discrimination test, and a standard odor identification test. As a result, 20 panelists were selected, who passed all of the tests. Before conducting the evaluation, all the panelists conducted a discussion to share information about the nature of each item to be evaluated and to share a common understanding. In order to prevent the panelists from making biased evaluations and to allow them to make accurate sensory evaluations, the panelists were not informed of what samples were tested or how the test samples were numbered, and the samples were presented at random to the panelists.

### Evaluation Method

A control sample of oil/fat composition was prepared by pan-frying Sangen pork back ribs over low heat for 10 minutes and then mixing the resulting melted and separated oil and fat with the meat juice. Each of the panelists ate the control oil/fat composition and memorized each of its flavors (minimum level of off-flavors, meaty flavor, sweet fat flavor, and minimum level of harsh and astringent tastes). Each panelist rated each of the flavors of each oil/fat composition on a scale of 1 to 10, where “10” was the score for each flavor of the “control” oil/fat composition. A score closer to 10 indicates a better meaty flavor, better masking of off-flavors (a lower level of off-flavors), a better sweet fat flavor, or a lower level of harsh and astringent tastes. The average of the scores given by the panelists was calculated and rounded to the nearest integer.

In the present examples, the composition is evaluated to have good flavors when the masking of off-flavors and the meaty flavor are each rated at least 3.

TABLE 1

| | | Example | Example | Example | Example | Example | Example | Example | Example |
|---|---|---|---|---|---|---|---|---|---|
| Example | | 1 | 2 | 3 | 4 | 5 | 6 | 7 | 8 |
| Addition target food | | Rapeseed | Rapeseed | Rapeseed | Rapeseed | Rapeseed | Rapeseed | Rapeseed | Rapeseed |
| | | oil | oil | oil | oil | oil | oil | oil | oil |
| Taste- | (A) Sulfurol | 208 | 250 | 625 | 1250 | 1667 | 2000 | 2222 | 2315 |
| improving | (B) | 2292 | 2250 | 1875 | 1250 | 833 | 500 | 278 | 185 |
| agent (ppm) | Hydroxymethylfurfural | | | | | | | | |
| | (C) Phenylethanal | 0 | 0 | 0 | 0 | 0 | 0 | 0 | 0 |
| | (D) Furfuryl | 0 | 0 | 0 | 0 | 0 | 0 | 0 | 0 |
| | alcohol | | | | | | | | |
| | (E) Isoamyl | 0 | 0 | 0 | 0 | 0 | 0 | 0 | 0 |
| | alcohol | | | | | | | | |
| (B)/(A) | | 11 | 9 | 3 | 1 | 0.5 | 0.25 | 0.125 | 0.0 [symbol] |
| (C)/(A) | | 0 | 0 | 0 | 0 | 0 | 0 | 0 | 0 |
| (D)/(A) | | 0 | 0 | 0 | 0 | 0 | 0 | 0 | 0 |
| (E)/(A) | | 0 | 0 | 0 | 0 | 0 | 0 | 0 | 0 |
| (C)/(B) | | 0 | 0 | 0 | 0 | 0 | 0 | 0 | 0 |
| (D)/(B) | | 0 | 0 | 0 | 0 | 0 | 0 | 0 | 0 |
| (E)/(B) | | 0 | 0 | 0 | 0 | 0 | 0 | 0 | 0 |
| Solid fat content at 20° C. | | 0 | 0 | 0 | 0 | 0 | 0 | 0 | 0 |
| (% by mass) | | | | | | | | | |
| Solid fat content at 30° C. | | 0 | 0 | 0 | 0 | 0 | 0 | 0 | 0 |
| (% by mass) | | | | | | | | | |
| Triolein (% by mass) | | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 |
| Evaluation | Masking of off- | 7 | 7 | 7 | 6 | 5 | 5 | 5 | 4 |
| | flavors | | | | | | | | |
| | Meaty flavor | 3 | 4 | 5 | 8 | 9 | 9 | 9 | 7 |
| | Sweet fat flavor | 4 | 4 | 4 | 3 | 2 | 2 | 2 | 2 |
| | Harsh and | 7 | 7 | 7 | 7 | 7 | 7 | 7 | 7 |
| | astringent tastes | | | | | | | | |
| | | Example | Example | Example | Example | Example | Example | Example | Example |
| Example | | 9 | 10 | 11 | 12 | 13 | 14 | 15 | 16 |
| Addition target food | | Rapeseed | Rapeseed | Rapeseed | Rapeseed | Rapeseed | Rapeseed | Rapeseed | Rapeseed |
| | | oil | oil | oil | oil | oil | oil | oil | oil |
| Taste- | (A) Sulfurol | 2380 | 720000 | 80000 | 60000 | 10000 | 800 | 400 | 200 |
| improving | (B) | 120 | 180000 | 20000 | 15000 | 2500 | 200 | 100 | 50 |
| agent (ppm) | Hydroxymethylfurfural | | | | | | | | |
| | (C) Phenylethanal | 0 | 0 | 0 | 0 | 0 | 0 | 0 | 0 |
| | (D) Furfuryl | 0 | 0 | 0 | 0 | 0 | 0 | 0 | 0 |
| | alcohol | | | | | | | | |
| | (E) Isoamyl | 0 | 0 | 0 | 0 | 0 | 0 | 0 | 0 |
| | alcohol | | | | | | | | |
| (B)/(A) | | 0.05 | 0.25 | 0.25 | 0.25 | 0.25 | 0.25 | 0.25 | 0.25 |
| (C)/(A) | | 0 | 0 | 0 | 0 | 0 | 0 | 0 | 0 |
| (D)/(A) | | 0 | 0 | 0 | 0 | 0 | 0 | 0 | 0 |
| (E)/(A) | | 0 | 0 | 0 | 0 | 0 | 0 | 0 | 0 |
| (C)/(B) | | 0 | 0 | 0 | 0 | 0 | 0 | 0 | 0 |
| (D)/(B) | | 0 | 0 | 0 | 0 | 0 | 0 | 0 | 0 |
| (E)/(B) | | 0 | 0 | 0 | 0 | 0 | 0 | 0 | 0 |
| Solid fat content at 20° C. | | 0 | 0 | 0 | 0 | 0 | 0 | 0 | 0 |
| (% by mass) | | | | | | | | | |
| Solid fat content at 30° C. | | 0 | 0 | 0 | 0 | 0 | 0 | 0 | 0 |
| (% by mass) | | | | | | | | | |
| Triolein (% by mass) | | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 |
| Evaluation | Masking of off- | 3 | 3 | 4 | 4 | 4 | 5 | 5 | 5 |
| | flavors | | | | | | | | |
| | Meaty flavor | 6 | 10 | 9 | 9 | 9 | 8 | 7 | 6 |
| | Sweet fat flavor | 2 | 2 | 2 | 2 | 2 | 2 | 2 | 2 |
| | Harsh and | 7 | 1 | 9 | 5 | 6 | 8 | 9 | 10 |
| | astringent tastes | | | | | | | | |

[symbol]

indicates data missing or illegible when filed

TABLE 2

| | | Example | Example | Example | Example | Example | Example | Example | Example |
|---|---|---|---|---|---|---|---|---|---|
| Example | | 17 | 18 | 19 | 20 | 21 | 22 | 23 | 24 |
| Addition target food | | Rapeseed | Rapeseed | Rapeseed | Rapeseed | Rapeseed | Rapeseed | Rapeseed | Rapeseed |
| | | oil | oil | oil | oil | oil | oil | oil | oil |
| Taste- | (A) Sulfurol | 100 | 48 | 24 | 24 | 24 | 24 | 200 | 200 |
| improving | (B) | 25 | 12 | 6 | 12 | 25 | 50 | 50 | 50 |
| agent (ppm) | Hydroxymethylfurfural | | | | | | | | |
| | (C) Phenylethanal | 0 | 0 | 0 | 0 | 0 | 0 | 0.1 | 0.2 |
| | (D) Furfuryl | 0 | 0 | 0 | 0 | 0 | 0 | 0 | 0 |
| | alcohol | | | | | | | | |
| | (E) Isoamyl | 0 | 0 | 0 | 0 | 0 | 0 | 0 | 0 |
| | alcohol | | | | | | | | |
| (B)/(A) | | 0.25 | 0.25 | 0.25 | 0.5 | 1.04 | 2.08 | 0.25 | 0.25 |
| (C)/(A) | | 0 | 0 | 0 | 0 | 0 | 0 | 0.0005 | 0.001 |
| (D)/(A) | | 0 | 0 | 0 | 0 | 0 | 0 | 0 | 0 |
| (E)/(A) | | 0 | 0 | 0 | 0 | 0 | 0 | 0 | 0 |
| (C)/(B) | | 0 | 0 | 0 | 0 | 0 | 0 | 0.002 | 0.004 |
| (D)/(B) | | 0 | 0 | 0 | 0 | 0 | 0 | 0 | 0 |
| (E)/(B) | | 0 | 0 | 0 | 0 | 0 | 0 | 0 | 0 |
| Solid fat content at 20° C. | | 0 | 0 | 0 | 0 | 0 | 0 | 0 | 0 |
| (% by mass) | | | | | | | | | |
| Solid fat content at 30° C. | | 0 | 0 | 0 | 0 | 0 | 0 | 0 | 0 |
| (% by mass) | | | | | | | | | |
| Triolein (% by mass) | | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 |
| Evaluation | Masking of off- | 5 | 5 | 5 | 6 | 8 | 9 | 4 | 5 |
| | flavors | | | | | | | | |
| | Meaty flavor | 5 | 4 | 3 | 3 | 3 | 3 | 6 | 6 |
| | Sweet fat flavor | 2 | 2 | 2 | 2 | 2 | 2 | 3 | 4 |
| | Harsh and | 10 | 10 | 10 | 10 | 10 | 10 | 10 | 10 |
| | astringent tastes | | | | | | | | |
| | | Example | Example | Example | Example | Example | Example | Example | Example |
| Example | | 25 | 26 | 27 | 28 | 29 | 30 | 31 | 32 |
| Addition target food | | Rapeseed | Rapeseed | Rapeseed | Rapeseed | Rapeseed | Rapeseed | Rapeseed | Rapeseed |
| | | oil | oil | oil | oil | oil | oil | oil | oil |
| Taste- | (A) Sulfurol | 200 | 200 | 200 | 200 | 200 | 200 | 200 | 200 |
| improving | (B) | 50 | 50 | 50 | 50 | 50 | 50 | 50 | 50 |
| agent (ppm) | Hydroxymethylfurfural | | | | | | | | |
| | (C) Phenylethanal | 0.4 | 2 | 10 | 40 | 80 | 2 | 2 | 2 |
| | (D) Furfuryl | 0 | 0 | 0 | 0 | 0 | 0.04 | 0.1 | 0.2 |
| | alcohol | | | | | | | | |
| | (E) Isoamyl | 0 | 0 | 0 | 0 | 0 | 0 | 0 | 0 |
| | alcohol | | | | | | | | |
| (B)/(A) | | 0.25 | 0.25 | 0.25 | 0.25 | 0.25 | 0.25 | 0.25 | 0.25 |
| (C)/(A) | | 0.002 | 0.01 | 0.05 | 0.2 | 0.4 | 0.01 | 0.01 | 0.01 |
| (D)/(A) | | 0 | 0 | 0 | 0 | 0 | 0.0002 | 0.0005 | 0.001 |
| (E)/(A) | | 0 | 0 | 0 | 0 | 0 | 0 | 0 | 0 |
| (C)/(B) | | 0.008 | 0.04 | 0.2 | 0.8 | 1.6 | 0.04 | 0.04 | 0.04 |
| (D)/(B) | | 0 | 0 | 0 | 0 | 0 | 0.0008 | 0.002 | 0.004 |
| (E)/(B) | | 0 | 0 | 0 | 0 | 0 | 0 | 0 | 0 |
| Solid fat content at 20° C. | | 0 | 0 | 0 | 0 | 0 | 0 | 0 | 0 |
| (% by mass) | | | | | | | | | |
| Solid fat content at 30° C. | | 0 | 0 | 0 | 0 | 0 | 0 | 0 | 0 |
| (% by mass) | | | | | | | | | |
| Triolein (% by mass) | | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 |
| Evaluation | Masking of off- | 5 | 5 | 5 | 5 | 5 | 6 | 7 | 8 |
| | flavors | | | | | | | | |
| | Meaty flavor | 7 | 7 | 7 | 6 | 5 | 7 | 7 | 8 |
| | Sweet fat flavor | 5 | 5 | 5 | 6 | 7 | 6 | 7 | 7 |
| | Harsh and | 10 | 10 | 10 | 10 | 10 | 10 | 10 | 10 |
| | astringent tastes | | | | | | | | |

TABLE 3

| | | Example | Example | Example | Example | Example | Example | Example | Example | Example |
|---|---|---|---|---|---|---|---|---|---|---|
| Example | | 33 | 34 | 35 | 36 | 37 | 38 | 39 | 40 | 41 |
| Addition target food | | Rapeseed | Rapeseed | Rapeseed | Rapeseed | Rapeseed | Rapeseed | Rapeseed | Rapeseed | Rapeseed |
| | | oil | oil | oil | oil | oil | oil | oil | oil | oil |
| Taste- | (A) Sulfurol | 200 | 200 | 200 | 200 | 200 | 200 | 200 | 200 | 200 |
| improving | (B) | 50 | 50 | 50 | 50 | 50 | 50 | 50 | 50 | 50 |
| agent (ppm) | Hydroxymethylfurfural | | | | | | | | | |
| | (C) Phenylethanal | 2 | 2 | 2 | 2 | 2 | 2 | 2 | 2 | 2 |
| | (D) Furfuryl | 1 | 5 | 20 | 40 | 1 | 1 | 1 | 1 | 1 |
| | alcohol | | | | | | | | | |
| | (E) Isoamyl | 0 | 0 | 0 | 0 | 0.1 | 0.2 | 0.4 | 2 | 10 |
| | alcohol | | | | | | | | | |
| (B)/(A) | | 0.25 | 0.25 | 0.25 | 0.25 | 0.25 | 0.25 | 0.25 | 0.25 | 0.25 |
| (C)/(A) | | 0.01 | 0.01 | 0.01 | 0.01 | 0.01 | 0.01 | 0.01 | 0.01 | 0.01 |
| (D)/(A) | | 0.005 | 0.025 | 0.1 | 0.2 | 0.005 | 0.005 | 0.005 | 0.005 | 0.005 |
| (E)/(A) | | 0 | 0 | 0 | 0 | 0.0005 | 0.001 | 0.002 | 0.01 | 0.05 |
| (C)/(B) | | 0.04 | 0.04 | 0.04 | 0.04 | 0.04 | 0.04 | 0.04 | 0.04 | 0.04 |
| (D)/(B) | | 0.02 | 0.1 | 0.4 | 0.8 | 0.02 | 0.02 | 0.02 | 0.02 | 0.02 |
| (E)/(B) | | 0 | 0 | 0 | 0 | 0.002 | 0.004 | 0.008 | 0.04 | 0.2 |
| Solid fat content at 20° C. | | 0 | 0 | 0 | 0 | 0 | 0 | 0 | 0 | 0 |
| (% by mass) | | | | | | | | | | |
| Solid fat content at 30° C. | | 0 | 0 | 0 | 0 | 0 | 0 | 0 | 0 | 0 |
| (% by mass) | | | | | | | | | | |
| Triolein (% by mass) | | 21.2 | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 | 0.0 |
| Evaluation | Masking of off- | 8 | [symbol] | 8 | 8 | 8 | 9 | 9 | 9 | 9 |
| | flavors | | | | | | | | | |
| | Meaty flavor | 8 | 8 | 7 | 6 | 8 | 8 | 9 | 9 | 9 |
| | Sweet fat flavor | 7 | 7 | 7 | 7 | 8 | 8 | 9 | 9 | 9 |
| | Harsh and | 10 | 10 | 10 | 10 | 10 | 10 | 10 | 10 | 10 |
| | astringent tastes | | | | | | | | | |

| | | Example | Example | Example | Example | Example | Example | Example |
|---|---|---|---|---|---|---|---|---|
| Example | | 42 | 43 | 44 | 45 | 46 | 47 | 48 |
| Addition target food | | Rapeseed | Rapeseed | Rapeseed | Rapeseed | Rapeseed | Rapeseed | Rapeseed |
| | | oil | oil | oil | oil | oil | oil | oil |
| Taste- | (A) Sulfurol | 200 | 200 | 2000 | 10000 | 60000 | 80000 | 720000 |
| improving | (B) | 50 | 50 | 500 | 2500 | 15000 | 20000 | 180000 |
| agent (ppm) | Hydroxymethylfurfural | | | | | | | |
| | (C) Phenylethanal | 2 | 2 | 20 | 100 | 600 | 800 | 7200 |
| | (D) Furfuryl | 1 | 1 | 10 | 50 | 300 | 400 | 3600 |
| | alcohol | | | | | | | |
| | (E) Isoamyl | 40 | [symbol] 0 | 20 | 100 | 600 | 800 | 7200 |
| | alcohol | | | | | | | |
| (B)/(A) | | 0.25 | 0.25 | 0.25 | 0.25 | 0.25 | 0.25 | 0.25 |
| (C)/(A) | | 0.01 | 0.01 | 0.01 | 0.01 | 0.01 | 0.01 | 0.01 |
| (D)/(A) | | 0.005 | 0.005 | 0.005 | 0.005 | 0.005 | 0.005 | 0.005 |
| (E)/(A) | | 0.2 | 0.4 | 0.01 | 0.01 | 0.01 | 0.01 | 0.01 |
| (C)/(B) | | 0.04 | 0.04 | 0.04 | 0.04 | 0.04 | 0.04 | 0.04 |
| (D)/(B) | | 0.02 | 0.02 | 0.02 | 0.02 | 0.02 | 0.02 | 0.02 |
| (E)/(B) | | 0.8 | 1.6 | 0.04 | 0.04 | 0.04 | 0.04 | 0.04 |
| Solid fat content at 20° C. | | 0 | 0 | 0 | 0 | 0 | 0 | 0 |
| (% by mass) | | | | | | | | |
| Solid fat content at 30° C. | | 0 | 0 | 0 | 0 | 0 | 0 | 0 |
| (% by mass) | | | | | | | | |
| Triolein (% by mass) | | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 |
| Evaluation | Masking of off- | 8 | [symbol] | 9 | 9 | 9 | [symbol] | 8 |
| | flavors | | | | | | | |
| | Meaty flavor | 9 | 9 | 9 | 9 | 9 | 9 | 9 |
| | Sweet fat flavor | 8 | 7 | 9 | 9 | 9 | 9 | 9 |
| | Harsh and | 10 | 10 | 7 | 6 | 5 | 4 | 1 |
| | astringent tastes | | | | | | | |

[symbol]

indicates data missing or illegible when filed

TABLE 4

| | | Example | Example | Example | Example | Example | Example | Example |
|---|---|---|---|---|---|---|---|---|
| Example | | 49 | 50 | 51 | 52 | 53 | 54 | 55 |
| Addition target food | | Sunflower | Coconut | Palm oil | Processed | Processed | Processed | Processed |
| | | oil | oil | | oil/fat1 | oil/fat2 | oil/fat3 | oil/fat4 |
| Taste- | (A) Sulfurol | 200 | 200 | 200 | 200 | 200 | 200 | 200 |
| improving | (B) | 50 | 50 | 50 | 50 | 50 | 50 | 50 |
| agent (ppm) | Hydroxymethylfurfural | | | | | | | |
| | (C) Phenylethanal | 2 | 2 | 2 | 2 | 2 | 2 | 2 |
| | (D) Furfuryl | 1 | 1 | 1 | 1 | 1 | 1 | 1 |
| | alcohol | | | | | | | |
| | (E) Isoamyl | 2 | 2 | 2 | 2 | 2 | 2 | 2 |
| | alcohol | | | | | | | |
| (B)/(A) | | 0.25 | 0.25 | 0.25 | 0.25 | 0.25 | 0.25 | 0.25 |
| (C)/(A) | | 0.01 | 0.01 | 0.01 | 0.01 | 0.01 | 0.01 | 0.01 |
| (D)/(A) | | 0.005 | 0.005 | 0.005 | 0.005 | 0.005 | 0.005 | 0.005 |
| (E)/(A) | | 0.01 | 0.01 | 0.01 | 0.01 | 0.01 | 0.01 | 0.01 |
| (C)/(B) | | 0.04 | 0.04 | 0.04 | 0.04 | 0.04 | 0.04 | 0.04 |
| (D)/(B) | | 0.02 | 0.02 | 0.02 | 0.02 | 0.02 | 0.02 | 0.02 |
| (E)/(B) | | 0.04 | 0.04 | 0.04 | 0.04 | 0.04 | 0.04 | 0.04 |
| Solid fat content at 20° C. | | 0 | 40 | 19 | 42 | 32 | 22 | 14 |
| (% by mass) | | | | | | | | |
| Solid fat content at 30° C. | | 0 | 0 | 9 | 2 | 16 | 5 | 8 |
| (% by mass) | | | | | | | | |
| Triolein (% by mass) | | 1.6 | 0.0 | 5.5 | 3.2 | 5.9 | 2.2 | 6.8 |
| Tripalmitin (% by mass) | | 0.0 | 0.0 | 6.2 | 6.1 | 8.0 | 1.8 | 6.3 |
| Evaluation | Masking of off- | 9 | 9 | 10 | 9 | 10 | 10 | 10 |
| | flavors | | | | | | | |
| | Meaty flavor | 9 | 10 | 10 | 10 | 10 | 10 | 10 |
| | Sweet fat flavor | 9 | 9 | 10 | 10 | 9 | 10 | 10 |
| | Harsh and | 10 | 10 | 10 | 10 | 10 | 10 | 10 |
| | astringent tastes | | | | | | | |

TABLE 5

| | | Compar- | Compar- | Compar- | Compar- | Compar- | Compar- | Compar- | Compar- |
|---|---|---|---|---|---|---|---|---|---|
| | | ative | ative | ative | ative | ative | ative | ative | ative |
| | | Example | Example | Example | Example | Example | Example | Example | Example |
| Example | | 1 | 2 | 3 | 4 | 5 | 6 | 7 | 8 |
| Addition target food | | Rapeseed | Rapeseed | Rapeseed | Rapeseed | Rapeseed | Rapeseed | Rapeseed | Rapeseed |
| | | oil | oil | oil | oil | oil | oil | oil | oil |
| Taste- | (A) Sulfurol | 0 | 2500 | 0 | 0 | 178 | 2450 | 0 | 0 |
| improving | (B) | 0 | 0 | 2500 | 0 | 2322 | 50 | 0 | 0 |
| agent (ppm) | Hydroxymethylfurfural | | | | | | | | |
| | (C) Phenylethanal | 0 | 0 | 0 | 2 | 0 | 0 | 0 | 0 |
| | (D) Furfuryl | 0 | 0 | 0 | 0 | 0 | 0 | 1 | 0 |
| | alcohol | | | | | | | | |
| | (E) Isoamyl | 0 | 0 | 0 | 0 | 0 | 0 | 0 | 2 |
| | alcohol | | | | | | | | |
| (B)/(A) | | — | 0 | — | — | 13 | 0.02 | — | — |
| (C)/(A) | | — | 0 | — | — | 0 | 0 | — | — |
| (D)/(A) | | — | 0 | — | — | 0 | 0 | — | — |
| (E)/(A) | | — | 0 | — | — | 0 | 0 | — | — |
| (C)/(B) | | — | — | 0 | — | 0 | 0 | — | — |
| (D)/(B) | | — | — | 0 | — | 0 | 0 | — | — |
| (E)/(B) | | — | — | 0 | — | 0 | 0 | — | — |
| Solid fat content at 20° C. | | 0 | 0 | 0 | 0 | 0 | 0 | 0 | 0 |
| (% by mass) | | | | | | | | | |
| Solid fat content at 30° C. | | 0 | 0 | 0 | 0 | 0 | 0 | 0 | 0 |
| (% by mass) | | | | | | | | | |
| Triolein (% by mass) | | 21.2 | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 | 0.0 |
| Evaluation | Masking of off- | 1 | 1 | 7 | 2 | 7 | 2 | 2 | 2 |
| | flavors | | | | | | | | |
| | Meaty flavor | 1 | [symbol] | 1 | 1 | 2 | 9 | 1 | 1 |
| | Sweet fat flavor | 1 | 1 | 4 | 2 | 4 | 2 | 2 | 2 |
| | Harsh and | 10 | 7 | 7 | 10 | 7 | 7 | 10 | 10 |
| | astringent tastes | | | | | | | | |

| | | Compar- | Compar- | Compar- | Compar- | Compar- | Compar- | Compar- |
|---|---|---|---|---|---|---|---|---|
| | | ative | ative | ative | ative | ative | ative | ative |
| | | Example | Example | Example | Example | Example | Example | Example |
| Example | | 9 | 10 | 11 | 12 | 13 | 14 | 15 |
| Addition target food | | Rapeseed | Rapeseed | Rapeseed | Rapeseed | Rapeseed | Rapeseed | Rapeseed |
| | | oil | oil | oil | oil | oil | oil | oil |
| Taste- | (A) Sulfurol | 2500 | 2500 | 2500 | 0 | 0 | 0 | 0 |
| improving | (B) | 0 | 0 | 0 | 2500 | 2500 | 2500 | 2500 |
| agent (ppm) | Hydroxymethylfurfural | | | | | | | |
| | (C) Phenylethanal | 25 | 0 | 0 | 25 | 0 | 0 | 25 |
| | (D) Furfuryl | 0 | 12.5 | 0 | 0 | 12.5 | 0 | 12.5 |
| | alcohol | | | | | | | |
| | (E) Isoamyl | 0 | 0 | 25 | 0 | 0 | 25 | 25 |
| | alcohol | | | | | | | |
| (B)/(A) | | 0 | 0 | 0 | — | — | — | — |
| (C)/(A) | | 0.01 | 0 | 0 | — | — | — | — |
| (D)/(A) | | 0 | 0.005 | 0 | — | — | — | — |
| (E)/(A) | | 0 | 0 | 0.01 | — | — | — | — |
| (C)/(B) | | — | — | — | 0.01 | 0 | 0 | 0.01 |
| (D)/(B) | | — | — | — | 0 | 0.005 | 0 | 0.005 |
| (E)/(B) | | — | — | — | 0 | 0 | 0.01 | 0.01 |
| Solid fat content at 20° C. | | 0 | 0 | 0 | 0 | 0 | 0 | 0 |
| (% by mass) | | | | | | | | |
| Solid fat content at 30° C. | | 0 | 0 | 0 | 0 | 0 | 0 | 0 |
| (% by mass) | | | | | | | | |
| Triolein (% by mass) | | 21.2 | 21.2 | 21.2 | 21.2 | 21.2 | 21.2 | 21.2 |
| Tripalmitin (% by mass) | | 0.0 | 0.0 | 0.0 | 0.0 | 0.0 | 0.0 | 0.0 |
| Evaluation | Masking of off- | 2 | 2 | 2 | [symbol] | 8 | [symbol] | [symbol] |
| | flavors | | | | | | | |
| | Meaty flavor | 5 | 5 | [symbol] | 1 | 1 | 1 | 1 |
| | Sweet fat flavor | 2 | 2 | 2 | 5 | 5 | 5 | 5 |
| | Harsh and | 7 | 7 | 7 | 7 | 7 | 7 | 7 |
| | astringent tastes | | | | | | | |

[symbol]

indicates data missing or illegible when filed

The examples shown in Tables 1 to 5 demonstrate that the oil/fat compositions containing sulfurol and hydroxymethylfurfural in a manner that satisfies the requirements according to the present invention had a good meaty flavor and less off-flavors.

When sulfurol and hydroxymethylfurfural were mixed in such a way as to satisfy the ratio requirement according to the present invention, a higher sulfurol content tended to provide a better meaty flavor with the appearance of off-flavors kept at low level.

The addition of phenylethanal, furfuryl alcohol, or isoamyl alcohol tended to reduce the appearance of off-flavors, to enhance not only the meaty flavor but also the sweet fat flavor, and to reduce the appearance of harsh and astringent tastes. As the concentration of the components of the taste-improving agent decreased, it tended to become easier to produce the harsh and astringent tastes-reducing effect.

### Test 2: Preparation of Soup

Soup (corresponding to a food or beverage product) was prepared containing the taste-improving agent prepared according to the example in Test 1. The soup was made using vegetable broth as the main raw material (vegetable broth soup). The soup contained each taste-improving component at the concentration shown in Table 6.

The resulting soup was evaluated as in Test 1. The results are shown in Table 6. Table 6 shows that the soup containing the taste-improving agent of the example had a good meaty flavor and less off-flavors.

### Test 3: Preparation of Soy Hamburger Patties

Soy hamburger patties (corresponding to food or beverage products) were prepared containing the taste-improving agent of Example 17, 40, or 55 or Comparative Example 6 prepared in Test 1. The soy hamburger patties were made mainly from dried defatted soybean granules and dried defatted soybean powder and were free of any animal-derived ingredient. The soy hamburger patties contained the taste-improving agent at the concentration shown in Table 7.

The resulting soy hamburger patties were evaluated as in Test 1. The results are shown in Table 7. Table 7 shows that the soy hamburger patties containing the taste-improving agent of the example had a good meaty flavor and less off-flavors. The soy hamburger patties containing the taste-improving agent of the example also had their beany flavor masked to provide improved palatability.

TABLE 6

| | | | | Compar- |
|---|---|---|---|---|
| | | | | ative |
| | | Exam- | Exam- | Exam- |
| | | ple | ple | ple |
| Example | | 56 | 57 | 16 |
| Addition target food | | Vegetable | Soy | Vegetable |
| | | broth soup | hamburger | broth soup |
| Taste- | (A) Sulfurol | 200 | 200 | 0 |
| improving | (B) Hydroxymethyl- | 50 | 50 | 50 |
| agent | furfural | | | |
| (ppm) | (C) Phenylethanal | 2 | 2 | 2 |
| | (D) Furfuryl alcohol | 1 | 1 | 1 |
| | (E) Isoamyl alcohol | 2 | 2 | 2 |
| (B)/(A) | | 0.25 | 0.25 | — |
| (C)/(A) | | 0.01 | 0.01 | — |
| (D)/(A) | | 0.005 | 0.005 | — |
| (E)/(A) | | 0.01 | 0.01 | — |
| (C)/(B) | | 0.04 | 0.04 | 0.04 |
| (D)/(B) | | 0.02 | 0.02 | 0.02 |
| (E)/(B) | | 0.04 | 0.04 | 0.04 |
| Solid fat content at 20° C. | | 14 | 14 | 14 |
| (% by mass) | | | | |
| Solid fat content at 30° C. | | 8 | 8 | 8 |
| (% by mass) | | | | |
| Evaluation | Masking of off- | 10 | 10 | 10 |
| | flavors | | | |
| | Meaty flavor | 10 | 10 | 1 |
| | Sweet fat flavor | 10 | 10 | 10 |
| | Harsh and | 10 | 10 | 10 |
| | astringent tastes | | | |

TABLE 7

| | | | | | Compar- |
|---|---|---|---|---|---|
| | | | | | ative |
| | | Exam- | Exam- | Exam- | Exam- |
| | | ple | ple | ple | ple |
| Example | | 58 | 59 | 60 | 17 |
| Oil/fat | Example17 | 20 | | | |
| composition | Example40 | | 20 | | |
| | Example55 | | | 20 | |
| | Comparative | | | | 20 |
| | Example6 | | | | |
| Soybean protein | | 18 | 18 | 18 | 18 |
| Onion | | 8 | 8 | 8 | 8 |
| Salt | | 0.8 | 0.8 | 0.8 | 0.8 |
| Black pepper | | 0.2 | 0.2 | 0.2 | 0.2 |
| Methylcellulose | | 1 | 1 | 1 | 1 |
| Water | | 52 | 52 | 52 | 52 |
| Total | | 100 | 100 | 100 | 100 |
| Evaluation | Masking of off- | 5 | 9 | 10 | 2 |
| | flavors | | | | |
| | Meaty flavor | 5 | 9 | 10 | 9 |
| | Sweet fat flavor | 2 | 9 | 10 | 2 |
| | Harsh and | 10 | 10 | 10 | 7 |
| | astringent tastes | | | | |

### Test 4: Evaluation of Oil/Fat Compositions

Some of the oil/fat compositions (plastic oil/fat compositions) prepared in Test 1 were subjected to analysis of constituent triglycerides and evaluation of plasticity.

### Preparation of Plastic Oil/Fat Compositions

The components listed in the “Taste-improving agent” column for each of Examples 51 to 55 in Table 4 were added to the “addition target food” (oil/fat), which was melted by heating under the same conditions as those for each of Examples 51 to 55, to form a uniform mixture. In a cooling mixer, the mixture was then rapidly cooled and kneaded to give a plastic oil/fat composition.

### Analysis of Constituent Triglycerides

Each of the resulting oil/fat compositions was analyzed for the contents shown below by gas chromatography based on The JOCS Standard Methods for the Analysis of Fats, Oils and Related Materials, 2.4.2.2-2013 Fatty Acid Composition (FID Temperature Programmed Gas Chromatography) and Recommended 2-2013 Composition of Fatty Acids in 2-Position. The results are shown in the “Constituent triglycerides” column of Table 8.
POP: The content of a triglyceride with palmitic acid residues in positions 1 and 3 and an oleic acid residue in position 2 in the oil/fat composition
PPO: The content of a triglyceride with palmitic acid residues in positions 1 and 2 and an oleic acid residue in position 3 in the oil/fat composition
POP/PPO: The mass ratio of POP to PPO

### Evaluation of Oil/Fat Compositions

The resulting oil/fat compositions were subjected to sensory evaluation for plasticity using the method shown below. The results are shown in the “Evaluation” column of Table 8.

The sensory evaluation was carried out by panelists who were selected as described below. Panelist candidates took a five-taste identification test (sweet, sour, salty, bitter, and umami), a taste intensity discrimination test, a food taste discrimination test, and a standard odor identification test. As a result, 20 panelists were selected, who passed all of the tests. Before conducting the evaluation, all the panelists conducted a discussion to share information about the nature of each item to be evaluated and to share a common understanding. In order to prevent the panelists from making biased evaluations and to allow them to make accurate sensory evaluations, the panelists were not informed of what samples were tested or how the test samples were numbered, and the samples were presented at random to the panelists.

### Evaluation Method

The oil/fat composition (5 g), of which the temperature was adjusted to 20° C., was taken on a spatula and then applied to a stainless steel plate when evaluated according to the following criteria.
⊙: The composition spread thinly and very smoothly. ◯: The composition spread thinly and smoothly.
Δ: The composition spread smoothly but remained slightly thick. X: The composition remained thick and had low spreadability or spread discontinuously.

TABLE 8

| | | Example | Example | Example | Example | Example |
|---|---|---|---|---|---|---|
| Example | | 51 | 52 | 53 | 54 | 55 |
| Addition target food | | Palm oil | Processed | Processed | Processed | Processed |
| | | | oil/fat1 | oil/fat2 | oil/fat3 | oil/fat4 |
| Constituent | POP | 24.7 | 30.5 | 7.5 | 1.7 | 16.0 |
| triglycerides | PPO | 5.9 | 4.0 | 15.1 | 3.4 | 10.4 |
| (% by mass) | POP/PPO | 4.2 | 7.7 | 0.5 | 0.5 | 1.5 |
| Evaluation | Plasticity | Δ | X | ⊙ | ◯ | ⊙ |

Table 8 shows that the oil/fat composition with a lower POP/PPO ratio tended to have better plasticity.

1. A taste-improving agent comprising:
sulfurol; and hydroxymethylfurfural, the taste-improving agent having a mass ratio of the hydroxymethylfurfural to the sulfurol of 0.03 or more and 12.00 or less.

2. The taste-improving agent according to claim 1, further comprising phenylethanal.

3. The taste-improving agent according to claim 1, further comprising furfuryl alcohol.

4. The taste-improving agent according to claim 1, further comprising isoamyl alcohol.

5. The taste-improving agent according to claim 1, wherein the taste-improving agent is for use in a food or beverage product selected from the group consisting of a prepared food product, a soup product, and a meat alternative food product.

6. A food or beverage product comprising the taste-improving agent according to any one of claims 1 to 5.

7. An oil and/or fat composition comprising the taste- improving agent according to any one of claims 1 to 5.

8. A food or beverage product comprising the oil and/or fat composition according to claim 7.

9. The oil and/or fat composition according to claim 7, wherein the oil and/or fat composition has a mass ratio of POP to PPO of 0.3 or more and 5.0 or less, wherein PPO represents a triglyceride with palmitic acid residues in positions 1 and 2 and an oleic acid residue in position 3, and POP represents a triglyceride with palmitic acid residues in positions 1 and 3 and an oleic acid residue in position 2.
